(19) United States
(12) Patent Application Publication
(10) Pub. No.: US 2001/0055090 A1
(43) Pub. Date: Dec. 27, 2001

(54) Liquid crystal display element manufacturing method and screen plate used therein

(76) Inventors: Masanori Negoro, Kaizuka-Shi (JP); Jun Yamada, Takatsuki-Shi (JP)

Correspondence Address: SIDLEY AUSTIN BROWN & WOOD, 717 NORTH HARWOOD, SUITE 3400, DALLAS, TX, 75201, US

(21) Appl. No.: 09/859,102

(22) Filed: May 16, 2001

(30) Foreign Application Priority Data
May 19, 2000 (JP) 2000-147396

(51) Int. Cl. G02F 1/13

(52) U.S. Cl. 349/187

(57) ABSTRACT

Disclosed is a liquid crystal display element manufacturing method in which resin bodies are formed on one of a pair of substrates of the element. A screen plate, which has multiple resin body forming holes which defines arrangement of the resin bodies on the substrate, is used for forming the resin bodies on the substrate. The resin body forming holes have varying pitches and/or diameters from the center area of the screen plate that corresponds to the squeegee center area in the direction of the squeegee width to the edge areas of the screen plate that correspond to the squeegee edge areas in the direction of the squeegee width, such that the resin bodies thus formed on the substrate will have a uniform pitch and/or height.

### CROSS-REFERENCE TO RELATED APPLICATION

This application is based on Japanese Patent Application No. 2000-147396 filed in Japan on May 19, 2000, the entire content of which is hereby incorporated by reference.

### BACKGROUND OF THE INVENTION

1. Field of the Invention

The present invention relates to a liquid crystal display element manufacturing method, and more particularly, to a method by which to form resin bodies on a substrate to be used in a liquid crystal display element comprising (i) a pair of substrates, (ii) a liquid crystal material contained therebetween, and (iii) multiple resin bodies that help to regulate the gap between the substrates.

The present invention also relates to a screen plate that is used in carrying out the method by which to form resin bodies on a substrate to be used in a liquid crystal display element.

2. Description of the Related Art

A liquid crystal display element generally comprises a pair of substrates and a liquid crystal material contained therebetween. In some cases, multiple resin bodies that contribute the regulation of the gap between the substrates are placed between the substrates. Such resin bodies are used in order to maintain the gap between the substrates at a prescribed level, or they operate as an adhesive to increase the bond between the substrates and therefore the strength of the liquid crystal display element.

Where a liquid crystal display element including resin bodies is prepared, column-shaped resin bodies of a prescribed height are formed at a prescribed pitch on one of the substrates, sealing walls used to contain the liquid crystal material between the substrates are formed on the other substrate, and these substrates are combined together, for example. The liquid crystal material is placed between the substrates during the sealing process, or it is injected into the gap between the substrates via the vacuum injection method after the substrates are combined.

As the method by which to form resin bodies on a substrate, the screen printing method is known in the art.

In the screen printing method, a screen plate in which are formed multiple resin body forming holes is placed over the substrate, a resin material by which to form resin bodies is placed on this screen plate, and a squeegee (a spatula-like elastic member, for example) is pressed down onto the screen plate with a prescribed pressure (a prescribed squeegee pressure) while being moved in a direction transverse to the width of the squeegee relative to the screen plate. In this way, the resin material is spread onto the screen plate while being extruded onto the substrate via the resin body forming holes of the screen plate, such that resin bodies are formed on the substrate.

However, when using the conventional resin body forming method via screen printing, variations may occur in the height and pitch of the resin bodies formed on the substrate.

If variations exist in the height and pitch of resin bodies that operate as an adhesive to combine the substrates, when the substrates are placed together, for example, the variations in height and pitch appear as variations in the gap between the substrates. Where flexible film substrates are used for the substrates, such variations directly lead to variations in the gap between the substrates when a combining pressure is simultaneously applied to the entire surface of both substrates.

If the gap between the substrates is not uniform, variation occurs in the thickness of the liquid crystal material layer, which adversely affects the image quality provided by the liquid crystal display element. Therefore, it is desired that the resin bodies be formed so that they are as uniform as possible in order to avoid the occurrence of variation in the height and pitch of the resin bodies and maintain a uniform gap between the substrates. In other words, uniformity in the height and pitch of the resin bodies formed on the substrate must be ensured.

### SUMMARY OF THE INVENTION

An object of the present invention, therefore, is to provide a method by which to manufacture a liquid crystal display element comprising (i) a pair of substrates, (ii) a liquid crystal material contained therebetween and (iii) multiple resin bodies that contribute the regulation of the gap between the substrates, said method including a resin body forming method that can easily form via screen printing resin bodies that are uniform in terms of pitch and height throughout the substrate, so that the gap between the substrates is uniform in the liquid crystal display element, thereby enabling a high-quality display to be obtained.

Another object of the present invention is to provide a screen plate that may be used to carry out the method of the present invention.

According to the research performed by the inventors of the present invention, in the process in which resin bodies are formed using screen printing, the diameter of the resin body forming holes of the screen plate is proportional to the height of the resin bodies formed thereby at any given location in terms of the direction along the squeegee width if the screen plate thickness and the squeegee pressure are constant during printing.

In the conventional resin body forming processes using screen printing, a screen plate in which are formed multiple resin body forming holes having the same diameter and pitch throughout the plate is used.

However, during printing, a tensile force that runs along the width of the squeegee is applied to the screen plate due to the pressing of the squeegee, and consequently, differences result in the diameter (the diameter or width in the direction along the squeegee width, in particular) and pitch of the resin body forming holes when the center area is compared with the edge areas in terms of the direction along the width of the squeegee.

This is due to the fact that the difference between the tensile force applied to the screen plate and the squeegee pressure is larger at the center area of the screen plate than the edge areas in terms of the direction of the width of the squeegee, i.e., (difference between squeegee pressure and tensile force at center area)>(difference between squeegee pressure and tensile force at edge areas).

Therefore, when the diameter and pitch of the resin body forming holes are uniform throughout the screen plate, the height of the resin bodies formed at the center area of the substrate becomes larger than the height of the resin bodies formed at the edge areas thereof, i.e., (height of resin bodies at center area)>(height of resin bodies at edge areas).

The pitch of the resin body forming holes also becomes larger at the center area than at the edge areas, i.e., (pitch of holes at center area) >(pitch of holes at edge areas), depending on the degree to which the screen plate stretches in the direction of the squeegee width.

In other words, the height and pitch of the resin bodies formed on the substrate gradually diminish from the center area to either edge area in terms of the direction along the squeegee width when a screen plate in which are formed resin body forming holes having a uniform diameter and pitch throughout is used.

The inventors of the present invention completed the present invention based on these observations.

In other words, the present invention provides the following liquid crystal display element manufacturing method and screen plate.

(1) Liquid Crystal Display Element Manufacturing Method

A manufacturing method for a liquid crystal display element that comprises a pair of substrates, a liquid crystal material contained therebetween, and multiple resin bodies that contribute the regulation of the gap between the substrates, said method including the steps of:

placing on the substrate on which resin bodies are to be formed a screen plate in which are formed multiple resin body forming holes;

placing on the screen plate a resin material by which to form resin bodies; and

moving the squeegee relative to the screen plate in a direction transverse to the width of the squeegee while keeping the squeegee in pressure contact with the screen plate using a prescribed pressure in order to extrude the resin material onto the substrate on which resin bodies are to be formed through the resin body forming holes of the screen plate, so that resin bodies are formed on the substrate, wherein the resin body forming holes of the screen plate have varying pitches and/or diameters from the center area of the screen plate that corresponds to the squeegee center area in the direction of the squeegee width to the edge areas of the screen plate that correspond to the squeegee edge areas in the direction of the squeegee width, such that the resin bodies formed on the substrate will have a uniform pitch and/or height.

(2) Screen Plate

A screen plate used in the liquid crystal display element manufacturing method described in the description (1) above, wherein the resin body forming holes formed therein have varying pitches and/or diameters from the center area that corresponds to the squeegee center area in the direction of the squeegee width to the edge areas that correspond to the squeegee edge areas in the direction of the squeegee width, so that the resin bodies formed on the substrate will have a uniform pitch and/or height.

Using the liquid crystal display element manufacturing method and screen plate pertaining to the present invention, resin bodies may be easily formed via the screen printing method on a resin body formation target substrate. In other words, resin bodies are easily formed on the substrate when (i) the screen plate is placed on the substrate, (ii) a resin material by which to form resin bodies is placed on the screen plate, and (iii) the squeegee is moved relative to the screen plate in the direction transverse to the width of the squeegee while the squeegee is kept in pressure contact with the screen plate using a prescribed pressure (a prescribed constant squeegee pressure) in order to spread the resin material onto the screen plate and extrude it onto the resin body formation target substrate through the resin body forming holes of the screen plate.

Moreover, because, taking into consideration the tensile force that may be applied in the direction along the squeegee width when the squeegee is pressed down, the screen plate used in the present invention has varying resin body forming hole pitches and/or diameters from the area corresponding to the center of the squeegee in the direction of the width thereof to the areas corresponding to the edges of the squeegee in the direction of the width thereof in order to ensure that the resin bodies formed on the substrate have a uniform pitch and/or height, resin bodies having a uniform pitch and height are formed throughout the substrate.

While it is preferred that the pitch and diameter of the resin body forming holes formed in the screen plate pertaining to the present invention increase from the area corresponding to the squeegee center area to the areas corresponding to the squeegee edge areas, such an increase may be implemented in stages or gradually on a continuous basis.

The diameter (the diameter in the direction along the squeegee width, in particular) of the resin body forming holes at the center area of the screen plate may be increased toward the edges thereof in accordance with the difference between the squeegee pressure and the tensile force applied to the screen plate, for example. In other words, while the invention is not limited to this implementation, the diameter of the resin body forming holes in the areas of the screen plate that correspond to the squeegee edge areas may be 10% to 20% larger than the diameter of the resin body forming holes in the area of the screen plate that corresponds to the squeegee center area. For example, where the width of the resin bodies to be formed is 100 μm, the increase in diameter should be approximately 10 μm to 20 μm.

In addition, while the implementation of the present invention is no way limited hereby, the pitch of the resin body forming holes may also be increased by approximately 5% to 10% from the area of the screen plate that corresponds to the squeegee center area to the areas of the screen plate that correspond to the squeegee edges. For example, where the pitch of the resin bodies to be formed is 500 μm, the pitch should be increased by approximately 25 μm to 50 μm.

It is preferred that the resin body forming holes be two-dimensionally arranged on the screen plate. More preferably, the arrangement be a two-dimensional matrix fashion. It is preferred that each resin body ultimately have a column configuration

### BRIEF DESCRIPTION OF THE DRAWINGS

These and other objects, advantages and features of the invention will become apparent from the following description thereof taken in conjunction with the accompanying drawings in which:

FIG. 1 is a basic side view showing one example of the resin body forming device to carry out the resin body forming processes of the liquid crystal display element manufacturing method pertaining to the present invention;

FIG. 2 is a drawing showing the screen plate seen from above;

FIG. 3 is a drawing showing the resin bodies being formed on a substrate using the resin body forming device shown in FIG. 1;

FIG. 4 is a drawing showing the resin body forming holes of the screen plate and the state of the resin bodies during printing; and

FIG. 5 is a side view of a substrate on which resin bodies are formed being combined with another substrate using uniform pressure applied to the entire surface of both substrates.

### DETAILED DESCRIPTION OF THE PREFERRED EMBODIMENTS

An embodiment of the present invention is explained below with reference to the drawings.

Since the U.S. Pat. No. 6,226,067 fully discloses examples of liquid crystal display elements (liquid crystal light modulating elements) that are capable of being manufactured by the following method, an explanation of the structure thereof is omitted in this specification.

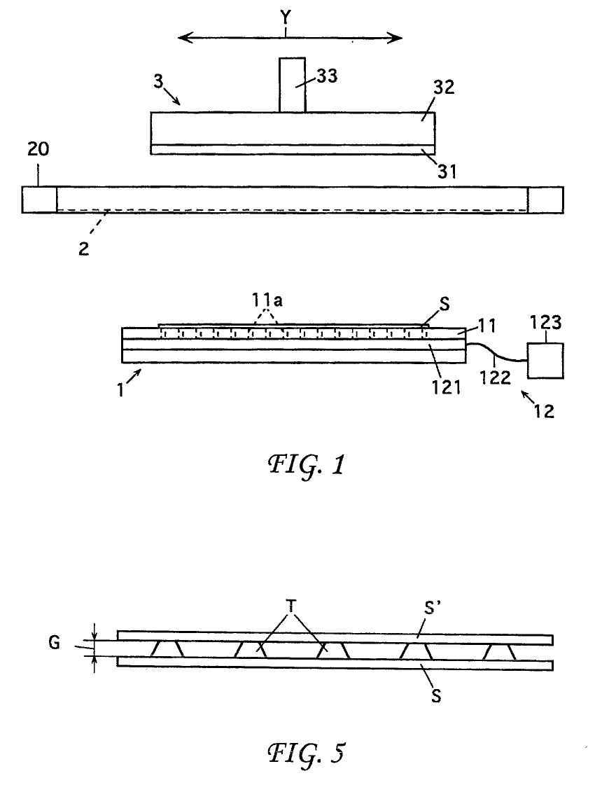

FIG. 1 is a basic side view showing an example of the device that forms resin bodies on a substrate that is used in any one of the liquid crystal display elements.

The resin body forming device shown in FIG. 1 is a device that forms resin bodies or resin structural nodules T (see FIG. 3) on a resin body formation target substrate S (a flexible film substrate in this embodiment) using the screen printing method. This device comprises a platform 1, a screen plate 2 stretched and held in a holder frame 20, and a squeegee 3. This resin body forming device can be an improved and detailed embodiment of the resin structural nodule forming method disclosed in FIG. 15 of the above mentioned U.S. Pat. No. 6,226,067 (hereinafter referred as '067 patent). That is to say, the following specific resin body forming method can be one of the steps of the manufacturing method disclosed in the '067 patent, and the disclosure of the '067 patent is incorporated herewith.

The platform 1 includes a suction table 11 and a substrate holding device 12 that holds the substrate.

The suction table 11 has at prescribed intervals multiple suction holes 11a through which the substrate S is sucked or attracted onto the table in the area on which the substrate S is held

The substrate holding device 12 also includes, in addition to the suction holes 11a, an exhaust chamber 121 in the suction table, a tube 122 and an exhaust device 123, which is connected to one end of the tube 122. The other end of the tube 122 is connected to the exhaust chamber 121. The exhaust chamber 121 is linked to the suction holes 11a of the suction table 11. When the exhaust device 123 is operated, air is sucked in through the suction holes Ha and expelled through the exhaust chamber 121 and tube 122, such that the substrate S may be held.

The screen plate 2 has multiple resin body forming holes 2′ (see FIG. 3), and is placed over the substrate S held on the platform 1.

The screen plate 2 is formed of metal and has a uniform thickness, and multiple small resin body forming holes 2′ are formed in the range over which resin bodies T are printed (formed) on the substrate S. A resin material (thermoplastic resin in this embodiment) by which to form resin bodies T is placed on the screen plate 2. As the resin material, for example, thermosetting resin can also be employed.

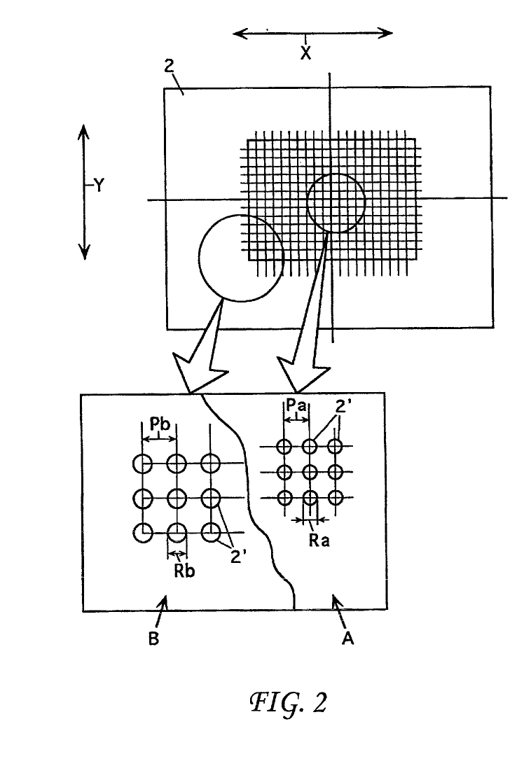

FIG. 2 shows the screen 2 when viewed from above. In the drawing, the part A shows an enlargement of a part of the center area of the screen plate 2 in terms of the direction Y along the squeegee width, while the part B shows an enlargement of a part of an edge area of the screen plate 2 in terms of the direction Y along the squeegee width. Although not shown in the drawing, the other edge area of the screen plate 2 has the same configuration as that shown in the part B.

As shown in FIG. 2, in the screen plate 2, the pitches and diameters of the resin body forming holes 2′ gradually increase from the center area to the edge areas in terms of the direction Y along the squeegee width.

The diameters of the resin body forming holes 2′ of the screen plate 2 are increased from the center area to either edge area in terms of the direction Y along the squeegee width in accordance with the difference between the squeegee pressure and the tensile force applied to the screen plate 2.

In other words, the diameter Rb (see the part B in the drawing) of the resin body forming holes 2′ in either edge area is increased by 10% to 20% from the diameter Ra (see the part A in the drawing) at the center area, and more specifically, by approximately 10 μm, assuming the width of the resin body T to be formed to be 100 μm.

The pitch Pb of the resin body forming holes 2′ at either edge area is also increased by approximately 5% to 10% from the pitch Pa at the center area, and more specifically, by approximately 40 μm, assuming the pitch of the resin bodies T to be formed to be 500 μm.

The squeegee 3 shown in FIG. 1 includes an elastic squeegee member 31, a plate-shaped member 32, and a grip member 33. The elastic squeegee member 31 comprises a rubber member in this embodiment, and is supported by the rigid plate-shaped member 32. The grip member 33 is mounted to the plate-shaped member 32.

When resin bodies T are to be printed on the substrate S, the screen plate 2 is placed over the substrate S, and a resin material M by which to form the resin bodies T is placed on the screen plate 2 as described above. The squeegee member 31 of the squeegee 3 is pressed against the screen plate 2 via a prescribed pressure (a prescribed constant squeegee pressure) P1 applied through the grip member 33, and the squeegee 3 is moved such that it slides in the direction X, which is perpendicular to the direction Y along the squeegee width. Through this operation, the resin material M may be spread onto the screen plate 2 while it is extruded onto the substrate S through the resin body forming holes 2′ of the screen plate 2. Resin bodies T are formed on the substrate S as a result.

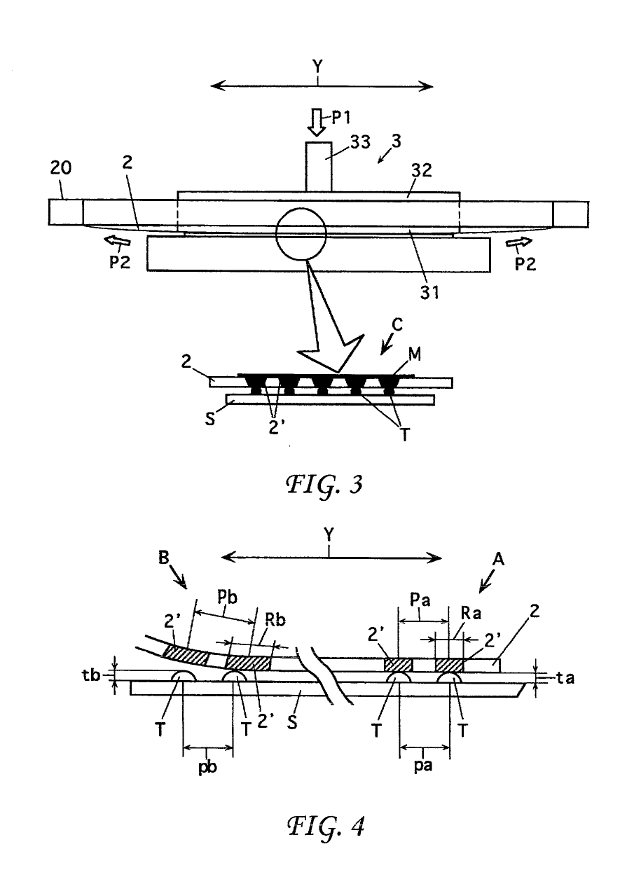

FIG. 3 shows resin bodies T being formed on the substrate S using the resin body forming device shown in FIG. 1. The part C in the drawing shows a cross-section of an enlargement of a part of the screen plate 2 and the substrate S. In the drawing, the arrow P2 indicates the tensile force that is applied to the screen plate 2 during printing. In addition, the drawing C exaggerates the gap between the screen plate 2 and the substrate S in order to make it easier to recognize the resin bodies T. This is also true with regard to FIG. 4 described below.

As shown in FIG. 3, when the squeegee 3 is moved under a prescribed pressure P1 in the direction X relative to the screen plate 2, which is perpendicular to the direction Y along the squeegee width, the resin material M is spread onto the screen plate 2 and extruded onto the substrate S via the resin body forming holes 2′ of the screen plate 2, such that resin bodies T may be easily printed (formed) on the substrate S. During this printing, the thickness of the screen plate 2 and the squeegee pressure P1 remain constant, and tensile force P2 is applied to the screen plate 2.

Taking into consideration the tensile force that may be applied in the direction Y along the squeegee width when the squeegee is pressed down, the pitches and diameters of the resin body forming holes 2′ gradually increase from the area that corresponds to the center area of the squeegee to the edge areas that correspond to the squeegee edge areas in terms of the direction Y along the width of the squeegee 3, such that the pitch and diameter of the resin bodies T formed on the substrate S may be uniform, and therefore resin bodies T having a uniform pitch and height are formed throughout the substrate S.

In other words, because the pitch Pb of the resin body forming holes 2′ at either edge area of the screen plate 2 is approximately 40 μm larger than the pitch Pa of the resin body forming holes 2′ in the center area, or 500 μm in this embodiment, and the diameter Rb of the resin body forming holes 2′ at either edge area is approximately 10 μm larger than the diameter Ra of the resin body forming holes 2′ at the center area, or 100 μm in this embodiment, the heights ta and tb and the pitches Pa and Pb of the resin bodies T formed on the substrate S may be made uniform to that extent. The process by which this is achieved is shown in FIG. 4.

A substrate S on which resin bodies T are formed and another substrate S′, which is different from the first substrate S, are combined together throughout their entirety using a constant pressure, as shown in FIG. 5, such that the gap G between the substrates may be made uniform throughout.

As described above, by employing the manufacturing method and the screen plate of the above mentioned embodiment, resin bodies that are uniform in terms of pitch and height can be easily formed throughout the substrate via screen printing, so that the gap between the substrates may be made uniform in the resulting liquid crystal display element, thereby enabling the resin body formation method to provide a high-quality display.

Furthermore, using the present invention a screen plate that may be used in the implementation of the method of the present invention may be provided.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A manufacturing method for a liquid crystal display element that comprises a pair of substrates, a liquid crystal material contained therebetween, and multiple resin bodies that contribute the regulation of the gap between the substrates, said method including the steps of:
placing on one of the substrates on which resin bodies are to be formed a screen plate in which are formed multiple resin body forming holes;
placing on the screen plate a resin material by which to form resin bodies; and
moving the squeegee relative to the screen plate in a direction transverse to the width of the squeegee while keeping the squeegee in pressure contact with the screen plate using a prescribed pressure in order to extrude the resin material onto the substrate on which resin bodies are to be formed through the resin body forming holes of the screen plate, so that resin bodies are formed on the substrate,
wherein the resin body forming holes of the screen plate have varying pitches and/or diameters from the center area of the screen plate that corresponds to the squeegee center area in the direction of the squeegee width to the edge areas of the screen plate that correspond to the squeegee edge areas in the direction of the squeegee width, such that the resin bodies formed on the substrate will have a uniform pitch and/or height.

2. A manufacturing method as claimed in claim 1, wherein the pitch and/or diameter of the resin body forming holes formed at the edge areas of the screen plate is greater than the pitch and/or diameter of the resin body forming holes formed at the center area of the screen plate.

3. A manufacturing method as claimed in claim 1, wherein each of the resin bodies will have a column shape connecting the pair of substrates when the pair of substrates are stacked each other.

4. A manufacturing method as claimed in claim 1, wherein at least one of the pair of substrates is flexible.

5. A manufacturing method as claimed in claim 1, wherein the pitches and/or diameters are gradually varied from the center area of the screen plate to the edge areas of the screen plate.

6. A manufacturing method as claimed in claim 1, wherein the pitches and/or diameters are varied from the center area of the screen plate to the edge areas of the screen plate in stepwise fashion.

7. A manufacturing method as claimed in claim 1, wherein the diameters in the direction along the squeegee width of the resin body forming holes are increased from the center area of the screen plate toward the edges thereof in accordance with the difference between the squeegee pressure and the tensile force applied to the screen plate.

8. A manufacturing method as claimed in claim 1, wherein the diameter of the resin body forming holes in the areas of the screen plate that correspond to the squeegee edge areas is 10% to 20% larger than the diameter of the resin body forming holes in the area of the screen plate that corresponds to the squeegee center area.

9. A manufacturing method as claimed in claim 1, wherein the pitches of the resin body forming holes are increased by approximately 5% to 10% from the area of the screen plate that corresponds to the squeegee center area to the areas of the screen plate that correspond to the squeegee edges.

10. A manufacturing method as claimed in claim 1, wherein the resin body forming holes are arranged in a matrix fashion in said screen plate.

11. A manufacturing method as claimed in claim 1, further comprising the step of overlapping the pair of substrates each other so that the resin bodies connect the pair of substrates.

12. A manufacturing method as claimed in claim 11, wherein the liquid crystal material on one of the pair of substrate before the pair of substrates are overlapped.

13. A manufacturing method as claimed in claim 11, wherein the liquid crystal material on one of the pair of substrate after the pair of substrates are overlapped.

14. A manufacturing method as claimed in claim 1, wherein at least a part of the squeegee that is in contact with the screen plate has an elasticity.

15. A manufacturing method as claimed in claim 1, further comprising the step of placing on a suction table the one of the substrates on which the screen plate is to be placed.

16. A screen plate for forming resin bodies on one of a pair of substrates between which a liquid crystal material is contained, said screen plate comprises a plurality of resin body forming holes formed therein have varying pitches and/or diameters from the center area that corresponds to the squeegee center area in the direction of the squeegee width to the edge areas that correspond to the squeegee edge areas in the direction of the squeegee width, so that the resin bodies formed on the substrate will have a uniform pitch and/or height.

17. A screen plate as claimed in claim 16, wherein the pitch and/or diameter of the resin body forming holes formed at the edge areas of the screen plate is greater than the pitch and/or diameter of the resin body forming holes formed at the center area of the screen plate.

18. A screen plate as claimed in claim 16, wherein the resin body forming holes are arranged in a matrix fashion in said screen plate.

19. A screen plate as claimed in claim 16, wherein the pitches and/or diameters are gradually varied from the center area of the screen plate to the edge areas of the screen plate.

20. A screen plate as claimed in claim 16, wherein the pitches and/or diameters are varied from the center area of the screen plate to the edge areas of the screen plate in stepwise fashion.

21. A screen plate as claimed in claim 16, wherein the diameters in the direction along the squeegee width of the resin body forming holes are increased from the center area of the screen plate toward the edges thereof in accordance with the difference between the squeegee pressure and the tensile force applied to the screen plate.
